(19) United States
(12) Patent Application Publication
(10) Pub. No.: US 2023/0004778 A1
(43) Pub. Date: Jan. 5, 2023

(54) METHOD AND SYSTEM FOR ON-DEVICE INFERENCE IN A DEEP NEURAL NETWORK (DNN)

(71) Applicant: SAMSUNG ELECTRONICS CO., LTD., Suwon-si (KR)

(72) Inventors: Sai Karthikey PENTAPATI, Bengaluru (IN); Amit SHUKLA, Bengaluru (IN); Kinsuk DAS, Bengaluru (IN); Raj Narayana GADDE, Bengaluru (IN); Sandeep MISHRA, Bengaluru (IN); Sarvesh, Bengaluru (IN); Sandeep PALAKKAL, Bengaluru (IN)

(21) Appl. No.: 17/857,731

(22) Filed: Jul. 5, 2022

(30) Foreign Application Priority Data
Jul. 5, 2021 (IN) 202141030178
Jun. 27, 2022 (IN) 202141030178

(51) Int. Cl. G06N 3/04; G06K 9/62; G06F 7/76

(52) U.S. Cl. CPC G06N 3/04; G06K 9/6296; G06F 7/76

(57) ABSTRACT

The disclosure relates to method and system for on-device inference in a deep neural network (DNN). The method comprises: determining whether one or more layers of the DNN satisfy one of a first, a second and a third condition, the one or more layers including one or more convolution layers and one or more resampling layers; performing the on-device inference based on the determination, wherein performing the on-device inference comprises at least one of: optimizing the one or more convolution layers in the one or more parallel branches based on the one or more layers of the DNN satisfying the first condition, optimizing the at least one of the resampling layers based on the one or more layers of the DNN satisfying the second condition, and modifying operation of the at least one of the resampling layers based on the one or more layers of the DNN satisfying the third condition.

### CROSS-REFERENCE TO RELATED APPLICATIONS

This application is based on and claims priority under 35 U.S.C. § 119 to Indian Provisional Patent Application No. 202141030178, filed on Jul. 5, 2021, in the Indian Patent Office, and to Indian Complete Patent Application No. 202141030178, filed on Jun. 27, 2022, in the Indian Patent Office, the disclosures of all of which are incorporated by reference herein in their entireties.

### BACKGROUND

### Field

The disclosure relates to method and system for optimizing neural networks (NN) for on-device deployment in an electronic device.

### Description of Related Art

On device inference is a key component of realizing solutions based on machine learning, such as video quality enhancement solutions (d-blur, d-noise etc.), on to a resource constraint compute medium, such as a mobile device. A solution can't be put into device if the architecture is not device friendly e.g., inference time is higher and takes lot of power. For example, video based and low latency application where either inference engine can run from minutes to hours, performance, power, and latency become important criterion determining the feasibility of the deployment. Modern compute elements leverage their design capabilities to run operations optimally. For example, processing time of a neural processing unit (NPU) in a deep neural network (DNN) is agnostic to number of filters in a convolution layer when maximum number of filters is below a threshold. For example, a 1 filter convolution, 2 filter convolution and 32 filter convolution takes same time on device due to agnostic behavior of the NPU. Similarly, some of the compute elements are optimized to perform optimally, when dimension is low, and channel is high. For instance, the NPU runs optimally when width and height is lower irrespective of number of channels up to a threshold, such as 32, 64. In addition, there are many operations which run optimally only for specific configurations. For example, depth to space layers work well for smaller configurations like (2*2). However, when the degree of the configuration increases, for example, to (4*4), then the performance of the DNN drops drastically.

Hence, there is a need to provide techniques which address the above discussed problems.

### SUMMARY

In an example embodiment, the present disclosure provides to a method for on-device inference in a deep neural network (DNN). The method comprises: determining whether one or more layers of the DNN satisfy one of a first, a second and a third condition, the one or more layers including one or more convolution layers and one or more resampling layers, wherein: the first condition includes whether the one or more convolutional layers are placed in one or more parallel branches of the DNN, the second condition includes whether at least one of the resampling layers has a specified first resampling ratio, and the third condition includes whether at least one of the resampling layers is followed by a convolution layer; performing the on-device inference based on the determination, wherein performing the on-device inference comprises at least one of: optimizing the one or more convolution layers in the one or more parallel branches based on the one or more layers of the DNN satisfying the first condition, optimizing the at least one of the resampling layers based on the one or more layers of the DNN satisfying the second condition, and modifying operation of the at least one of the resampling layers based on the one or more layers of the DNN satisfying the third condition.

In an example embodiment of the disclosure, a system for on-device inference in a deep neural network (DNN) is provided. The system comprises: a memory and a processor coupled to the memory. The processor is configured to: determine whether one or more layers of the DNN satisfy one of a first, a second and a third condition, the one or more layers including one or more convolution layers and one or more resampling layers, wherein:

the first condition includes whether the one or more convolutional layers are placed in one or more parallel branches of the DNN, the second condition includes whether at least one of the resampling layers has a specified first resampling ratio, and the third condition includes whether at least one of the resampling layers is followed by a convolution layer; the processor is further configured to: perform the on-device inference based on the determination, wherein performing the on-device inference comprises at least one of: optimizing the one or more convolution layers in the one or more parallel branches based on the one or more layers of the DNN satisfying the first condition, optimizing the at least one of the resampling layers based on the one or more layers of the DNN satisfying the second condition, and modifying operation of the at least one of the resampling layers based on the one or more layers of the DNN satisfying the third condition

To further clarify the advantages and features of the present disclosure, a detailed description will be provided with reference to specific embodiments thereof, which is illustrated in the appended drawings. It is appreciated that these drawings depict only example embodiments and are therefore not to be considered limiting its scope. The disclosure will be described and explained with additional specificity and detail with the accompanying drawings.

### BRIEF DESCRIPTION OF THE DRAWINGS

These and other features, aspects, and advantages of certain embodiments of the present disclosure will be more apparent from the following detailed description, taken in conjunction with the accompanying drawings, in which:

FIG. 1 is a flowchart illustrating an example method for on-device inference in a deep neural network (DNN), according to various embodiments;

FIG. 2 is a diagram illustrating an inference graph including parallel branches of convolution layers, in accordance with existing art;

FIG. 3 is a diagram illustrating example on-device inference in a deep neural network (DNN), according to various embodiments;

FIG. 4 is a diagram illustrating example on-device inference in a deep neural network (DNN), according to various embodiments;

FIG. 5 is a diagram illustrating example on-device inference in a deep neural network (DNN), according to various embodiments;

FIG. 6 is a diagram illustrating an example modifying operation of resampling layer, according to various embodiments; and

FIG. 7 is a block diagram illustrating an example configuration of a system for on-device inference in a deep neural network (DNN), according to various embodiments.

Further, skilled artisans will appreciate that elements in the drawings are illustrated for simplicity and may not have been necessarily drawn to scale. For example, the flowcharts illustrate the method in terms of operations involved to help to improve understanding of aspects of the present disclosure. Furthermore, in terms of the construction of the device, one or more components of the device may have been represented in the drawings by conventional symbols, and the drawings may illustrate specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to example embodiments illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would occur to one skilled in the art to which the disclosure relates.

It will be understood by those skilled in the art that the foregoing general description and the following detailed description are explanatory of the disclosed embodiments and are not intended to be restrictive thereof.

Reference throughout this disclosure to “an aspect”, “another aspect” or similar language may refer, for example, to a particular feature, structure, or characteristic described in connection with an embodiment being included in at least one embodiment of the present disclosure. Thus, appearances of the phrase “in an embodiment”, “in another embodiment” and similar language throughout this disclosure may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

DNNs are trained to make predictions against previously unseen data using deep learning inference. An inference graph contains a sequence of processing steps of the DNN. In an embodiment, the inference graph may be modified to optimize the performance of the DNN, as described in greater detail below with reference to the accompanying drawings.

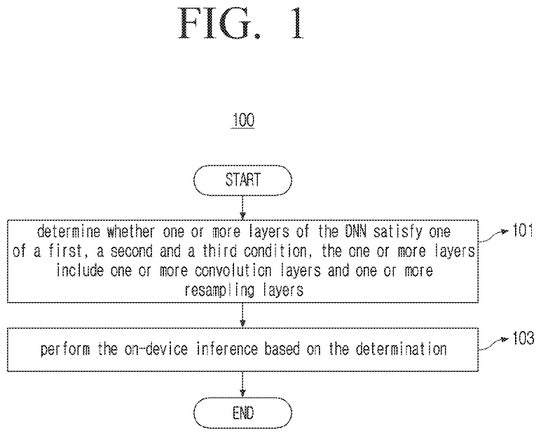

FIG. 1 flowchart illustrating an example method 100 for on-device inference in a deep neural network (DNN), according to various embodiments. In an embodiment, the DNN may comprise of plurality of layers. The plurality of layers may include convolution layers and resampling layers such as depth-to-space layers, space-to-depth layers, transpose convolution layers etc.

As shown in FIG. 1, at operation 101, the method 100 may comprise determining whether one or more layers of the DNN satisfy one of a first, a second and a third condition. In an embodiment, the one or more layers may include one or more convolution layers and one or more resampling layers.

At operation 103, the method 100 may comprise performing the on-device inference based on the determination.

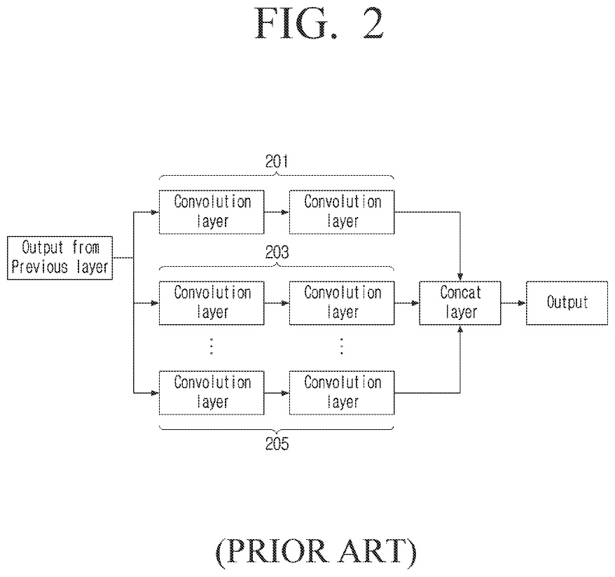

In an embodiment, the first condition corresponds to whether the one or more convolutional layers are placed in one or more parallel branches of the DNN. For example, as shown in FIG. 2, the inference graph may comprise of plurality of convolution layers arranged in three parallel branches (201, 203, 205). Total time taken during inference depends on time (T1) taken for inference of convolution layer, number of convolution layers, number of branches, and time (T2) taken for inference of concatenation layer. In particular, total time taken during inference=T1(convolution)*number of convolution layer per branch*number of branches+T2(concatenation).

Hence, the greater the number of convolution layers and branches, is the greater the total time taken during inference. Hence, there is a need to optimize the total inference time.

Accordingly, if the first condition is satisfied, then, at operation 103, the one or more convolution layers in the one or more parallel branches may be optimized. In an embodiment, to optimize the one or more convolution layers, the one or more parallel branches may be combined in the inference graph.

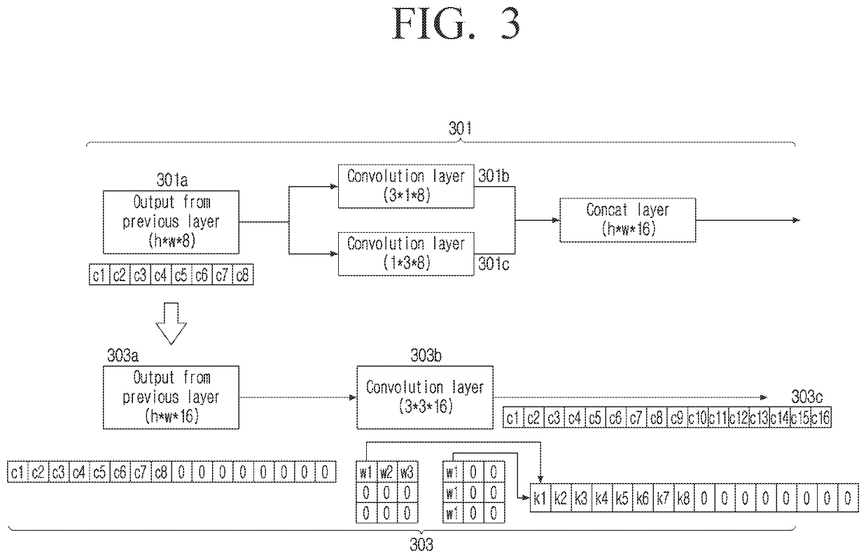

FIG. 3 is a diagram illustrating example on-device inference in a deep neural network (DNN), according to various embodiments. As shown in FIG. 3, as per existing art (depicted as 301), let us assume that an output from a previous convolution layer 301a is received with configuration of (h*w*8) and then fed to an inference graph having two parallel branches. Each branch has a single convolution layer 301b, 301c of different configuration, such as (3*1*8) and (1*3*8) on which inference is performed. After performing the inference on the individual convolution layers, output of inference is combined is fed to a concatenation layer of configuration of (h*w*16). Hence, inference has to be performed two times on the convolution layers as there are two parallel branches.

This results in increase in inference time.

On the other hand, in an embodiment of the disclosure (as depicted as 303), if the parallel branches are combined, then the inference has to be performed only once on a combined convolution layer, thereby reducing inference time. The inference can be performed in following manner:

First, the inference graph is received, and a number of channels required for a preceding convolution layer 303a is computed based on the received graph, for example, 16 channels are required in preceding convolution layer, as clear from 303. As actual number of channels in the preceding convolution layer 303a is 8, then, a number of filters are added in the preceding convolution layer 303a by adding a plurality of dummy weights. For example, 8 dummy weights (depicted as 0, 0, 0, 0, 0, 0, 0) are added in the preceding convolution layer 303a. Then, the one or more convolution layers (301b, 301c) placed in the one or more parallel branches are combined into one convolution layer 303b based on the added number of filters in the preceding convolution layer. For example, convolution layers 301b, 301c of different configuration of (3*1*8) and (1*3*8) are combined into a convolution layer 303b of a configuration of (3*3*16). Further, a common kernel size may be selected for the combined convolution layer 303b, wherein the kernel size is bigger than or equal to kernel size of each convolution layer 301b, 301c of the one or more convolutional layers. Filters and kernels are parameters of convolution layers. Filter size can be 3*3, 5*5, 7*7 etc. Then, a number of first filters required in each convolution layer 301b, 301c of each of the one or more parallel branches may be computed. A number of second filters required in the combined convolution layer 303b may be computed, wherein the number of second filters is equal to multiplication of the number of first filters in each convolution layer and number of the one or more parallel branches. For example, as shown in FIG. 3, there are 2 parallel branches and the number of first filters required in each convolution layer 301b, 301c is 8. Hence, number of second filters required in the combined convolution layer 303b is 2*8=16. A plurality of weights is adjusted for the first filters in the one or more parallel branches based on the number of extra filters added (such as 8) in the preceding convolution layer 303a and the number of second filters required (such as 16) in the combined convolution layer. In an embodiment, to adjust the plurality of weights, the number of extra filters in the preceding convolution layer 303a are modified such that the number of extra filters is equal to a number of channels of the one or more convolution layers after concatenation and a number of other filters are modified in the one or more convolution layers based on the modified number of extra filters in the preceding convolution layer. For example: 1*3*8, 3*1*8 is the first layer in 2 parallel branch, the combined filters is 16. For preceding layers, the filters should be increased from 8 to 16. The plurality of adjusted weights for filters in the combined convolution layer 303b are re-arranged and modifying the inference graph based on the re-arrangement. For example, as shown in FIG. 3, the modified inference graph 303c shows an output with 16 filters (e.g., c1, c2 - - - c16).

In an embodiment, the second condition corresponds to whether at least one of the resampling layers has a predefined (e.g., specified) first resampling ratio. In an embodiment, the predefined first resampling ratio is greater than or equal to 5. It should be noted that the predefined first resampling ratio is configurable and may be different for different DNN.

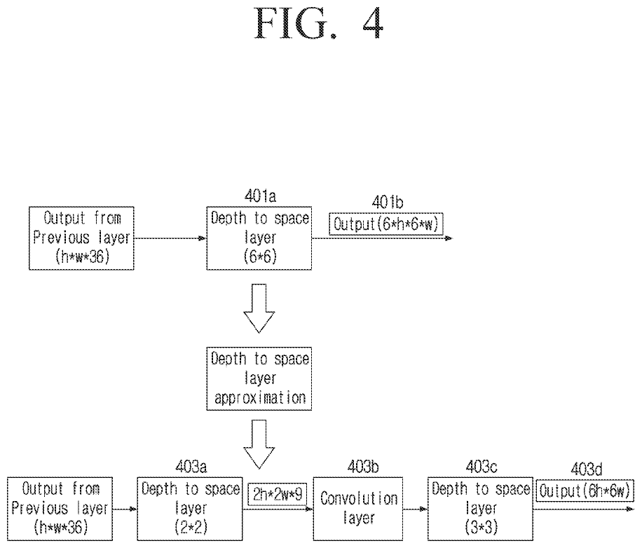

Referring back to FIG. 1, if the second condition is satisfied, then, at operation 103, at least one of the resampling layers may be optimized. FIG. 4 is a diagram illustrating example on-device inference in a deep neural network (DNN), according to various embodiments. In an example embodiment, the resampling layer is a depth-to-space layer. As shown in FIG. 4, to optimize the least one of the resampling layers, the resampling layer may be cascaded into a plurality of cascaded resampling layers of predefined second resampling ratio. The predefined second resampling ratio is smaller than the predefined first resampling ratio. For example, in FIG. 4, the at least one resampling layer 401a of the predefined first ratio (6*6) is cascaded into two cascaded resampling layers 403a, 403c of predefined second resampling ratio of 2*2 and 3*3, respectively. A convolution layer 403b is added between two cascaded resampling layers 403a, 403c among the plurality of cascaded resampling layers of the predefined second resampling ratio. An inference graph comprising of the resampling layers is modified based on the plurality of cascaded resampling layers 403a, 403c and the added convolution layer 403b. As can be seen from FIG. 4, that the configuration of resampling layer of the modified inference graph 403d is same as or similar to the inference graph 401b before optimization of resampling layer (also referred as resampling layer approximation). As the inference is performed on a resampling layer with smaller sampling ratio (e.g., ratio of 2 as compared to 6), the inference time is reduced.

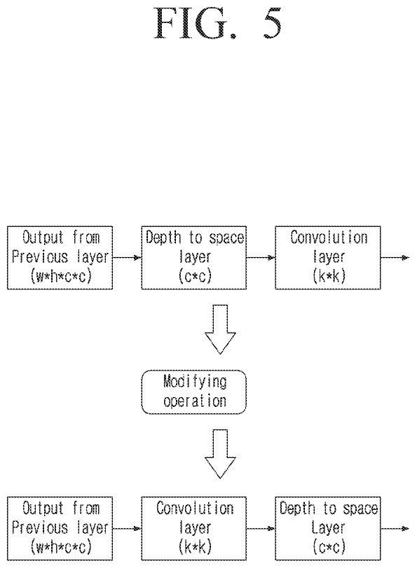

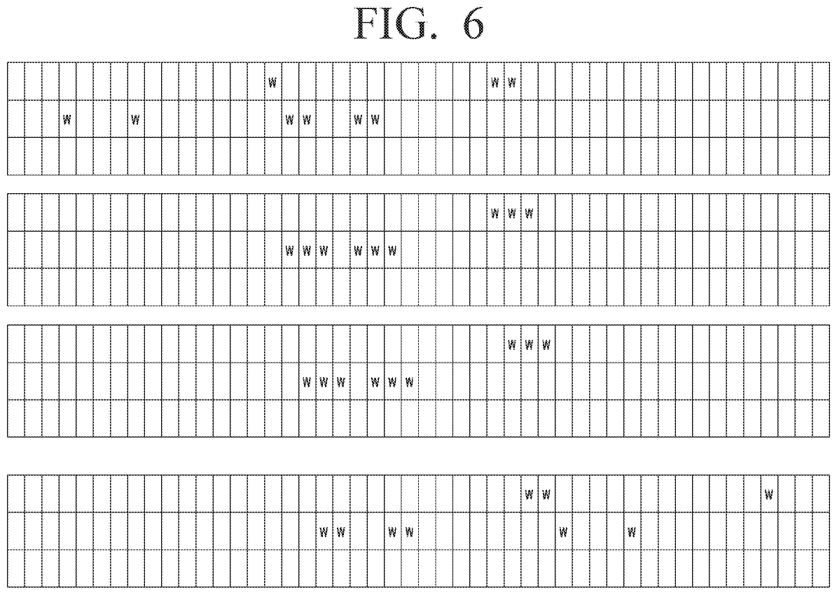

Referring back to FIG. 1, in an embodiment, the third condition corresponds to whether at least one of the resampling layers is followed by a convolution layer. If the third condition is satisfied, then, at operation 103, operation of the at least one of the resampling layers may be modified. In this example, inference may be performed on a convolution layer before performing dimension scaling operation an inference graph, as opposed to performing dimension scaling operation on the inference graph before performing inference on the convolution layer, as shown in FIG. 5. This way computations are performed in lower dimension (e.g., convolution layer) and higher channel, thereby reducing computational complexity. In this embodiment, weights for the convolution layer are modified and interleaved a plurality of dummy weights. The interleaved weights in filters of the convolutional layer are respaced and dimension scaling operation is performed on the inference graph. For example, as shown in FIG. 6, weight of 3*3*1 convolution to be applied on w*h*1 memory is adjusted to be applied on memory of size (w/4)*(h/4)*16 through weights rearrangement and dummy weight interleaving. Resampling layer is applied after this to get the data in expected dimension (w*h*1).

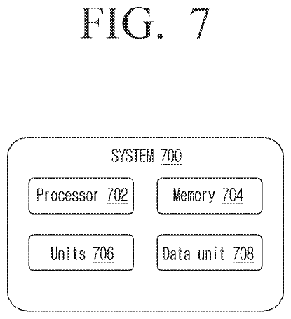

FIG. 7 is a block diagram illustrating an example configuration of a system 700 for on-device inference in a deep neural network (DNN), according to various embodiments. It should be noted that the system 700 may be a part of a device such as, but not limited to, mobile device, laptop, desktop, personal digital assistant (PDA) etc. For example, the system 700 may be a part of a camera system of a mobile device. The system 700 may include, but is not limited to, a processor (e.g., including processing circuitry) 702, memory 704, units (e.g., including various data, circuitry and/or executable instructions) 706, and data unit 708. The units 706 and the memory 704 may be coupled to the processor 702. The system 700 may be configured to perform methods as discussed in reference to FIGS. 1-6.

The processor 702 may include various processing circuitry and can be a single processing unit or several units, all of which could include multiple computing units. The processors 702 may be implemented as one or more microprocessors, microcomputers, microcontrollers, digital signal processors, central processing units, state machines, logic circuitries, and/or any devices that manipulate signals based on operational instructions. Among other capabilities, the processors 702 are configured to fetch and execute computer-readable instructions and data stored in the memory 704.

The memory 704 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The units 706 amongst other things, include routines, programs, objects, components, data structures, etc., which perform particular tasks or implement data types. The units 706 may also be implemented as, signal processor(s), state machine(s), logic circuitries, and/or any other device or component that manipulate signals based on operational instructions.

Further, the units 706 can be implemented in hardware, instructions executed by a processing unit, or by a combination thereof. The processing unit can comprise a computer, a processor, such as the processor 702 a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the units 706 may be machine-readable instructions (software) which, when executed by a processor/processing unit, perform any of the described functionalities.

The data units 708 serve, amongst other things, as a repository for storing data processed, received, and generated by one or more of the units 706 respectively.

Thus, the present disclosure provides following advantages:
Reduced Inference time such as reduced to 8 ms from 80 ms
Low power consumption by the device such as reduced to 50 ma from 200 ma
Reduced computational complexity

While specific language has been used to describe the disclosure, any limitations arising on account of the same are not intended. As would be apparent to a person in the art, various working modifications may be made to the method in order to implement the disclosure as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the disclosure or not, such as differences in structure, dimension, and use of material, are possible. The scope of embodiments is at least as broad as given by the following claims.

Benefits, other advantages, and solutions to problems have been described above with regard to example embodiments. However, the benefits, advantages, solutions to problems, and any component(s) that may cause any benefit, advantage, or solution to occur or become more pronounced are not to be construed as a critical, required, or essential feature or component of any or all the claims.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for on-device inference in a deep neural network (DNN), the method comprising:
determining whether one or more layers of the DNN satisfy one of a first, a second and a third condition, the one or more layers including one or more convolution layers and one or more resampling layers, wherein:
the first condition includes whether the one or more convolutional layers are placed in one or more parallel branches of the DNN;
the second condition includes whether at least one of the resampling layers has a specified first resampling ratio; and
the third condition includes whether at least one of the resampling layers is followed by a convolution layer; and
performing the on-device inference based on the determination, wherein performing the on-device inference comprises at least one of:
optimizing the one or more convolution layers in the one or more parallel branches, based on the one or more layers of the DNN satisfying the first condition;
optimizing the at least one of the resampling layers, based on the one or more layers of the DNN satisfying the second condition; and
modifying operation of the at least one of the resampling layers, based on the one or more layers of the DNN satisfying the third condition.

2. The method as claimed in claim 1, wherein optimizing the one or more convolution layers comprises:
receiving an inference graph;
computing a number of channels required for a preceding convolution layer based on the received graph, wherein the preceding convolution layer is preceding to the one or more convolution layers;
adding a number of filters in the preceding convolution layer by adding a plurality of dummy weights; and
combining the one or more convolution layers placed in the one or more parallel branches into one convolution layer based on the added number of filters in the preceding convolution layer.

3. The method as claimed in claim 2, further comprising:
selecting a common kernel size for the combined convolution layer, wherein the kernel size is greater than or equal to kernel size of each convolution layer of the one or more convolutional layers;
computing a number of first filters required in each convolution layer of each of the one or more parallel branches;
computing a number of second filters required in the combined convolution layer, wherein the number of second filters is equal to a product of the number of first filters in each convolution layer and a number of the one or more parallel branches;
adjusting a plurality of weights for the first filters in the one or more parallel branches based on the number of extra filters added in the preceding convolution layer and the number of second filters required in the combined convolution layer;
re-arranging the plurality of adjusted weights for filters in the combined convolution layer; and
modifying the inference graph based on the re-arranging.

4. The method as claimed in claim 3, wherein adjusting the plurality of weights comprises:
modifying the number of extra filters in the preceding convolution layer such that the number of extra filters is equal to a number of channels of the one or more convolution layers after concatenation, wherein the preceding convolution layer is preceding to the one or more convolution layers; and
modifying a number of other filters in the one or more convolution layers based on the modified number of extra filters in the preceding convolution layer.

5. The method as claimed in claim 1, wherein optimizing the at least one of the resampling layers comprises:
cascading the at least one of the resampling layers of the specified first resampling ratio into a plurality of cascaded resampling layers of a specified second resampling ratio, wherein the specified second resampling ratio is less than the specified first resampling ratio;
adding a convolution layer between two cascaded resampling layers among the plurality of cascaded resampling layers of the specified second resampling ratio; and
modifying an inference graph based on the plurality of cascaded resampling layers and the added convolution layer.

6. The method as claimed in claim 1, wherein, based on the at least one of the resampling layers being followed by the convolution layer, performing the inference comprises:
modifying weights for the convolution layer;
interleaving a plurality of dummy weights with the modified weights in filters of the convolutional layer;
respacing the interleaved weights in filters of the convolutional layer; and
performing a dimension scaling operation on an inference graph.

7. The method as claimed in claim 1, wherein the one or more resampling layers includes one or more depth to space layers or one or more transpose convolution layers.

8. The method as claimed in claim 1, wherein the specified first resampling ratio is greater than or equal to 5.

9. A system for on-device inference in a deep neural network (DNN), the system comprising:
a memory; and
a processor coupled to the memory and configured to:
determine whether one or more layers of the DNN satisfy one of a first, a second and a third condition, the one or more layers including one or more convolution layers and one or more resampling layers, wherein:
the first condition includes whether the one or more convolutional layers are placed in one or more parallel branches of the DNN;
the second condition includes whether at least one of the resampling layers has a specified first resampling ratio; and
the third condition includes whether at least one of the resampling layers is followed by a convolution layer; and
perform the on-device inference based on the determination, wherein performing the on-device inference comprises at least one of:
optimizing the one or more convolution layers in the one or more parallel branches, based on the one or more layers of the DNN satisfying the first condition;
optimizing the at least one of the resampling layers, based on the one or more layers of the DNN satisfying the second condition; and
modifying operation of the at least one of the resampling layers, based on the one or more layers of the DNN satisfying the third condition.

10. The system as claimed in claim 9, wherein for optimizing the one or more convolution layers, the processor is configured to:
receive an inference graph;
compute a number of channels required for a preceding convolution layer based on the received graph, wherein the preceding convolution layer is preceding to the one or more convolution layers;
add a number of filters in the preceding convolution layer by adding a plurality of dummy weights; and
combine the one or more convolution layers placed in the one or more parallel branches into one convolution layer based on the added number of filters in the preceding convolution layer.

11. The system as claimed in claim 10, wherein the processor is further configured to:
select a common kernel size for the combined convolution layer, wherein the kernel size is greater than or equal to kernel size of each convolution layer of the one or more convolutional layers;
compute a number of first filters required in each convolution layer of each of the one or more parallel branches;
compute a number of second filters required in the combined convolution layer, wherein the number of second filters is equal to a product of the number of first filters in each convolution layer and a number of the one or more parallel branches;
adjust a plurality of weights for the first filters in the one or more parallel branches based on the number of extra filters added in the preceding convolution layer and the number of second filters required in the combined convolution layer;
re-arrange the plurality of adjusted weights for filters in the combined convolution layer; and
modify the inference graph based on the re-arranging.

12. The system as claimed in claim 11, wherein for adjusting the plurality of weights, the processor is configured to:
modify the number of extra filters in the preceding convolution layer such that the number of extra filters is equal to a number of channels of the one or more convolution layers after concatenation, wherein the preceding convolution layer is preceding to the one or more convolution layers; and
modify a number of other filters in the one or more convolution layers based on the modified number of extra filters in the preceding convolution layer.

13. The system as claimed in claim 9, wherein for optimizing the at least one of the resampling layers, the processor is configured to:
cascade the at least one of the resampling layers of the specified first resampling ratio into a plurality of cascaded resampling layers of a specified second resampling ratio, wherein the specified second resampling ratio is less than the specified first resampling ratio;
add a convolution layer between two cascaded resampling layers among the plurality of cascaded resampling layers of the specified second resampling ratio; and
modify an inference graph based on the plurality of cascaded resampling layers and the added convolution layer.

14. The system as claimed in claim 9, wherein, based on the at least one of the resampling layers being followed by the convolution layer, for performing the inference, the processor is configured to:
modify weights for the convolution layer;
interleave a plurality of dummy weights with the modified weights in filters of the convolutional layer;
respace the interleaved weights in filters of the convolutional layer; and
perform dimension scaling operation on an inference graph.

15. The system as claimed in claim 9, wherein the one or more resampling layers includes one or more depth to space layers or one or more transpose convolution layers.

16. The system as claimed in claim 9, wherein the specified first resampling ratio is greater than or equal to 5.
